(19) United States
(12) Patent Application Publication
(10) Pub. No.: US 2007/0151384 A1
(43) Pub. Date: Jul. 5, 2007

(54) Dual detent system

(75) Inventors: Michael K. Humphrey, Southern Pines, NC (US); Patrick L. Scheib, Corneau, GA (US); Kenneth T. Picone, Pinehurst, NC (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/303,713

(22) Filed: Dec. 16, 2005

(51) Int. Cl. G05G 5/00; B60K 20/00

(52) U.S. Cl. 74/473.21

(57) ABSTRACT

A shift rail for a vehicle transmission includes multiple detent mechanisms for shifting that operate independently from each other. The shift rail includes a neutral detent mechanism that allows shifting from a neutral position into a gear engaged position at a first detent force, and an in-gear detent mechanism that allows shifting out of a gear engaged position at a second detent force that is greater than the first detent force. By setting the second detent force higher than the first detent force, un-requested shifts out of the gear engaged position, i.e. “jumpout,” can be controlled. Additionally, the neutral and in-gear detent mechanisms include separate springs where spring forces can be varied to adjust shift feel as needed.

### TECHNICAL FIELD

The subject invention relates to a transmission shift rail that has independent in-gear and in-neutral detents to control jumpout and allow adjustment of shift feel.

### BACKGROUND OF THE INVENTION

Heavy-duty vehicles, such as freight hauling Class 8 trucks, have a longer shift lever than shift levers found in passenger vehicles. Longer shift levers inherently have a high center of gravity. This high center of gravity makes certain shift levers more prone to un-requested shifts from an in-gear position to a neutral position. This phenomenon is often referred to as “jumpout.”

Different solutions have been used to reduce the occurrence of jumpout. One known solution provides a detent system. in combination with a control valve. The detent system includes a plunger with a tip that is received within the control valve. Pressure applied to the tip from the control valve is varied to selectively tailor detent forces. Another known solution provides a plunger actuator that is controlled to selectively extend and retract the plunger. These solutions are expensive and require complicated controls. Further, these methods can adversely affect shift feel when shifting from the neutral position to an in-gear position.

Thus, there is a need for a detent system that prevents the occurrence of jumpout, does not adversely affect shift feel, and which is also capable of adjusting shift feel.

### SUMMARY OF THE INVENTION

A vehicle transmission includes a top cover and a shift rail that is supported by the top cover. A neutral detent mechanism cooperates with the shift rail to provide a first detent force when shifting from a neutral position to a gear engaged position. A gear detent mechanism cooperates with the shift rail to provide a second detent force when shifting out of the gear engaged position. In one example, the second detent force is greater than the first detent force to reduce the occurrence of jumpout.

The neutral and in-gear detent mechanisms operate independently from each other. The neutral detent mechanism includes a first resiliently biased member and the in-gear detent mechanism includes a second resiliently biased member. The first and second resiliently biased members are supported within bores formed within the top cover. The first resiliently biased member has a first spring defining a first spring force and the second resiliently biased member has a second spring defining a second spring force. The first and second spring forces can be varied to “tune” or adjust shift feel.

The shift rail includes a first detent profile that engages the first resiliently biased member and a second detent profile that engages the second resilient biased member. The first detent profile has a first contoured surface and the second detent profile has a second contoured surface. In one example, the second contoured surface has a sharper or steeper profile surface than the first contoured surface. This steeper groove surface requires a more aggressive shift force for shifting out of the gear engaged position. The first contoured surface has a more gradual or shallower groove surface that provides a good shift feel for an operator when shifting out of the neutral position and into the gear engaged position.

Thus, the subject invention provides a detent system that controls the occurrence of jumpout without adversely affecting shift feel, and which can be tuned to adjust shift feel. These and other features of the present invention can be best understood from the following specification and drawings, the following of which is a brief description.

### BRIEF DESCRIPTION OF THE DRAWINGS

FIG. 1 is a cross-sectional view of a top cover and shift rail assembly incorporating the subject invention.

FIG. 2A is one example of a contoured surface on the shift rail for a neutral detent mechanism.

FIG. 2B is one example of a contoured surface on the shift rail for a gear detent mechanism.

FIG. 3 is a schematic view of one example of in-gear and neutral detent mechanisms having different spring forces.

### DETAILED DESCRIPTION OF THE PREFERRED EMBODIMENT

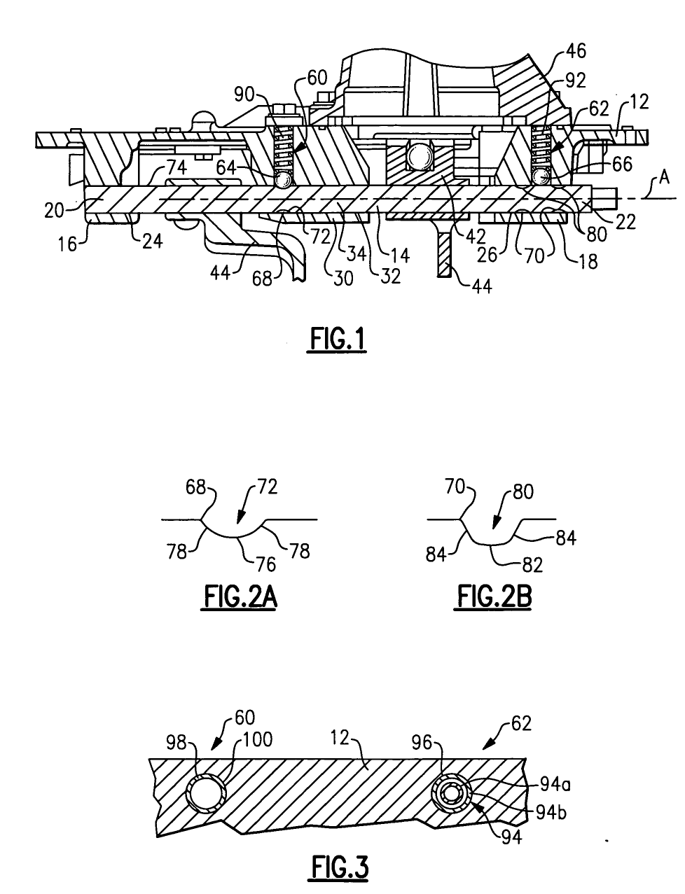

A top cover 12 and a shift rail 14 as used in a vehicle transmission (not shown) are shown in FIG. 1. The top cover 12 includes a first support member 16 and a second support member 18. The shift rail 14 includes a first end portion 20 and a second end portion 22. The first end portion 20 is supported within a bore 24 formed in the first support member 16 and the second end portion 22 is supported within a bore 26 formed in the second support member 18.

The top cover 12 also includes a central support member 30 that is positioned between the first 16 and second 18 support members. The central support member 30 includes a bore 32 that receives a center portion 34 of the shift rail 14.

The shift rail 14 defines an axis A that extends along a length of the shift rail 14. The shift rail 14 is axially moveable within the bores 24, 26, 32 in response to shift requests.

A stub lever (not shown) is coupled to the shift rail 14 to communicate shift requests from an operator to the shift rail 14. The stub lever cooperates with a shift sleeve 42, which is coupled to the shift rail 14, to perform shifting requests. Shift forks 44 are connected to the shift rail 14 to provide gear shifting. The shift forks 44 cooperate with clutch collars (not shown) to engage a desired gear as known. The stub lever is mounted within a shift lever housing 46 that is fastened or otherwise attached to the top cover 12.

A neutral detent mechanism 60 cooperates with the shift rail 14 to provide a first detent force when shifting from a neutral position to a gear engaged position. An in-gear detent mechanism 62 cooperates with the shift rail 14 to provide a second detent force when shifting out of the gear engaged position. The second detent force is greater than the first detent force to reduce the occurrence of jumpout. As previously explained, jumpout refers to a shifting phenomena in which the transmission inadvertently shifts from an in-gear position to a neutral position without a corresponding shift request from the operator.

Additionally, the use of separate detent mechanisms, i.e., the neutral detent mechanism 60 and the in-gear detent mechanism 62, allows for “tuning” or adjustment of shift feel. This will be discussed in greater detail below.

The neutral 60 and in-gear 62 detent mechanisms operate independently from each other. In one configuration, the neutral detent mechanism 60 operates at a lower detent force to provide a desired shift feel for the operator. The in-gear detent mechanism 62 operates at a higher detent force to reduce the occurrence of jumpout without affecting the desired shift feel for shifting out of the neutral position and into the gear engaged position. In another example configuration, the neutral detent mechanism 60 could operate at a higher detent force and the in-gear detent mechanism 62 could operate at a lower detent force.

The neutral detent mechanism 60 includes a first member 64 and the in-gear detent mechanism 62 includes a second member 66. The first 64 and second 66 members are supported within bores formed within the top cover 12. A first spring 90 resiliently biases the first member 64 and a second spring 92 resiliently biases the second member 66. This provides a dual spring configuration in which tuning of shift feel can be accomplished by using different spring forces and spring configurations.

The neutral detent mechanism 60 cooperates with a first detent profile formed on the shift rail 14. The first detent profile is defined by a first contoured surface 68. The gear detent mechanism 62 cooperates with a second detent profile formed on the shift rail 14. The second detent profile is defined by a second contoured surface 70 that is axially spaced apart from the first contoured surface 68 along the axis A.

The first contoured surface 68 preferably forms a groove 72 that extends inwardly from an outer peripheral surface 74 of the shift rail 14 toward the axis A. As shown in FIG. 2A, the groove 72 includes a central base portion 76 and a pair of outwardly extending side portions 78 that transition from the central base portion 76 to the outer peripheral surface 74.

The second contoured surface 70 preferably forms at least one groove 80 that extends inwardly from the outer peripheral surface 74 of the shift rail 14 toward the axis A. As shown in FIG. 2B, the groove 80 includes a central base portion 82 and a pair of outwardly extending side portions 84 that transition from the central base portion 82 to the outer peripheral surface 74.

The second contoured surface 70 has a sharper or steeper surface profile (FIG. 2B) at the pair of outwardly extending side portions 84 than the first contoured surface 68 has. This steeper surface profile requires a harder, more aggressive, shift force for shifting out of the gear engaged position, which reduces inadvertent jumpout. The first contoured surface 68 has a more gradual or shallower groove surface (FIG. 2A) that provides a good shift feel for an operator when shifting out of the neutral position and into the gear engaged position.

To further “tune” or adjust shift feel, spring configurations for the first 90 and second 92 springs can be varied. For example, the first 90 and second 92 springs can have different spring forces. Preferably, the in-gear detent mechanism 62 includes a stiffer or higher spring force than the neutral detent mechanism 60. This would provide a more aggressive or higher effort shift feel to shift out of an in-gear engaged position compared to shifting out of a neutral position.

In another example, shown in FIG. 3, the spring configuration for the in-gear detent mechanism 62 includes a nested spring assembly 94 that is received within a bore 96 formed within the top cover 12. The nested spring assembly 94 includes an inner coil spring 94a that is surrounded by an outer coil spring 94b. The neutral detent mechanism 60 includes a single coil spring 98 that is received within a bore 100 formed within the top cover 12. The inner 94a and outer 94b coil springs cooperate to require a higher shift effort for shifting out of an in-gear engaged position than for shifting out of neutral.

It should be understood that varying spring force between the first 90 and second 92 springs and using nested springs are just a few examples of how varying spring configurations can be used to tune shift feel. Other spring configurations could also be used.

Also, it should be understood that FIGS. 2A-2B are just a few examples of different surface profiles, and that other surface profile configurations could also be used with the neutral 60 and gear 62 detent mechanisms. Additionally, different surface profiles can be used in conjunction with different spring forces to provide an even finer degree of shift tuning. For example, the neutral 60 and in-gear 62 detent mechanisms could have different surface profiles from each other in combination with different spring forces. Optionally, the neutral 60 and in-gear 62 detent mechanisms could have different surface profiles with the same spring forces. In another configuration, the neutral 60 and in-gear 62 detent mechanisms could have the same surface profile with different spring forces.

Finally, it should be understood that the top cover 12, shift rail 14, neutral detent mechanism 60, and gear detent mechanism 62 can be used with any type of transmission configuration including transmissions with countershafts and/or range gear shafts.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A shift rail assembly for a vehicle transmission comprising:
a shift rail;
a neutral detent mechanism cooperating with said shift rail to provide a first detent force when shifting from a neutral position to a gear engaged position; and
an in-gear detent mechanism cooperating with said shift rail to provide a second detent force when shifting out of said gear engaged position wherein said first detent force is different than said second detent force.

2. The shift rail assembly according to claim 1 wherein said second detent force is greater than said first detent force.

3. The shift rail assembly according to claim 1 wherein said in-gear detent mechanism operates independently from said neutral detent mechanism.

4. The shift rail assembly according to claim 1 wherein said shift rail includes a first surface defined by a first detent profile and a second surface defined by a second detent profile different from said first detent profile, said first detent profile cooperating with said neutral detent mechanism and said second detent profile cooperating with said in-gear detent mechanism.

5. The shift rail assembly according to claim 4 wherein said second detent profile is steeper than said first detent profile.

6. The shift rail assembly according to claim 1 wherein said neutral detent mechanism includes a first spring having a first spring force and said in-gear detent mechanism includes a second spring having a second spring force, said first and second springs cooperating with said shift rail to define said first and second detent forces.

7. The shift rail assembly according to claim 6 wherein said first and second spring forces are varied to adjust shift feel.

8. The shift rail assembly according to claim 6 wherein said first and second spring forces are different from each other.

9. The shift rail assembly according to claim 6 wherein said shift rail includes a first surface defined by a first detent profile and a second surface defined by a second detent profile different from said first detent profile, said first detent profile cooperating with said neutral detent mechanism and said second detent profile cooperating with said in-gear detent mechanism.

10. The shift rail assembly according to claim 1 wherein said in-gear detent mechanism is separate from said neutral detent mechanism.

11. A method of shifting a vehicle transmission comprising the steps of:
(a) shifting from a neutral position to a gear engaged position with a neutral detent mechanism that engages a shift rail with a first detent force; and
(b) shifting out of the gear engaged position with an in-gear detent mechanism that engages the shift rail with a second detent force that is different than the first detent force.

12. The method according to claim 11 including operating the neutral detent mechanism and the gear detent mechanism independently from each other.

13. The method according to claim 11 wherein step (a) includes engaging the neutral detent mechanism against a first contoured surface on the shift rail and wherein step (b) includes engaging the in-gear detent mechanism against a second contoured surface on the shift rail wherein the first and second contoured surfaces are axially spaced apart from each other along a length of the shift rail.

14. The method according to claim 13 wherein the neutral detent mechanism includes a first spring having a first spring force and the in-gear detent mechanism includes a second spring having a second spring force, and including the step of varying the first and second spring forces from each other to adjust shift feel.

15. The method according to claim 11 wherein the second detent force is greater than the first detent force.

16. The method according to claim 11 wherein step (a) includes engaging a first resiliently biased member against a first detent profile formed on the shift rail and wherein step (b) includes engaging a second resiliently biased member, different from the first resiliently biased member, against a second detent profile formed on the shift rail.

17. The method according to claim 11 including the steps of providing a first spring force for the neutral detent mechanism and a second spring force for the in-gear detent mechanism, and tuning shift feel to a desired configuration by varying the first and second spring forces relative to each other.

18. The method according to claim 11 including separating the in-gear detent mechanism and the neutral detent mechanism from each other.
